(19) United States
(12) Patent Application Publication
(10) Pub. No.: US 2015/0256770 A1
(43) Pub. Date: Sep. 10, 2015

(54) SOLID-STATE IMAGE SENSOR DEVICE

(71) Applicant: Kabushiki Kaisha Toshiba, Minato-ku (JP)

(72) Inventors: Shoji SETA, Arakawa (JP); Fumio Izawa, Yokohama (JP)

(73) Assignee: Kabushiki Kaisha Toshiba, Minato-ku (JP)

(21) Appl. No.: 14/475,777

(22) Filed: Sep. 3, 2014

Related U.S. Application Data
(60) Provisional application No. 61/949,760, filed on Mar. 7, 2014.

(51) Int. Cl. H04N 5/353; H04N 5/235; H01L 27/146

(52) U.S. Cl. CPC H04N 5/353; H01L 27/14609; H04N 5/2353

(57) ABSTRACT

A solid-state image sensor device according to an embodiment includes an image pickup section, a first read signal line, a second read signal line, and an exposure time control section. The image pickup section includes a plurality of pixels arranged two-dimensionally in a matrix form. The first read signal line controls reading of charge accumulated in the plurality of pixels and be connected to a first pixel arranged in a center of a first row on which the plurality of pixels are arranged. The second read signal line controls reading of charge accumulated in the plurality of pixels and be connected to a second pixel arranged in a periphery outside the center of the first row. The exposure time control section performs control so that an exposure time of the second pixel becomes longer than an exposure time of the first pixel.

### FIELD

Embodiments described herein relate generally to a solid-state image sensor device.

### BACKGROUND

Conventionally, solid-state image sensor devices are widely used as image sensors. Image sensors are mounted on various apparatuses such as camera apparatuses, and, as the number of pixels of solid-state image sensor devices increases, pixel sizes are further being reduced in recent years.

In such solid-state image sensor devices, a phenomenon called shading occurs in which the amount of signal decreases in a periphery of lenses where an incident light level is low. In recent years, with miniaturization of pixel size and influences of refraction coefficients of lenses, there is a problem that the amount of signal further decreases in the periphery of lenses where an incident light level is low. An example of a method of correcting such shading is changing the pitch of a microlens or correcting acquired image data.

However, it is becoming structurally more difficult to change the pitch of a microlens due to miniaturization in recent years. Another problem is that data processing takes time when acquired image data is corrected.

Moreover, introducing a function of controlling an ES exposure time of unit pixels in a horizontal direction improves shading in a vertical direction to a certain extent, but shading in the horizontal direction still remains, and shading in corners where the amount of signal decreases most is not improved. In this scheme, shading tends to further worsen as miniaturization of pixels advances.

### BRIEF DESCRIPTION OF THE DRAWINGS

FIG. 1 is a block diagram illustrating an example of a configuration of a solid-state image sensor device according to a first embodiment;

FIG. 2 is a block diagram illustrating a detailed configuration of an image pickup region 3 of the present embodiment;

FIG. 3 is a timing chart illustrating timing at which a pixel signal is acquired from a unit pixel 11;

FIG. 4 is a diagram illustrating a relationship between an image pickup region and an amount of signal;

FIG. 5 is a block diagram illustrating an example of a configuration of a solid-state image sensor device according to a second embodiment;

FIG. 6 is a timing chart illustrating timing at which a pixel signal is acquired from the unit pixel 11;

FIG. 7 is a block diagram illustrating an example of a configuration of a solid-state image sensor device according to a third embodiment;

FIG. 8 is a block diagram illustrating a detailed configuration of an image pickup region 3a of the present embodiment;

FIG. 9 is a diagram illustrating a relationship between the unit pixel 11 of the image pickup region 3 and an amount of signal;

FIG. 10 is a timing chart illustrating timing at which a pixel signal is acquired from the unit pixel 11; and

FIG. 11 is a diagram illustrating an exposure time of each unit pixel 11 of the image pickup region 3.

### DETAILED DESCRIPTION

A solid-state image sensor device according to an embodiment includes an image pickup section, a first read signal line, a second read signal line, and an exposure time control section. The image pickup section is configured to include a plurality of pixels two-dimensionally arranged in a matrix form. The first read signal line is configured to control reading of charge accumulated in a plurality of pixels and be connected to first pixels arranged at a center of a first row on which the plurality of pixels are arranged. The second read signal line is configured to control reading of charge accumulated in a plurality of pixels and be connected to second pixels arranged in a periphery outside the center of the first row. The exposure time control section is configured to control an exposure time of the second pixels so as to be longer than an exposure time of the first pixels.

A solid-state image sensor device according to another embodiment includes an image pickup section, a first read signal line, a second read signal line, and an exposure time control section. The image pickup section is configured to include a plurality of pixels two-dimensionally arranged in a matrix form. The first read signal line is configured to control reading of charge accumulated in a plurality of pixels and be connected to pixels of any one given row on which the plurality of pixels are arranged. The second read signal line is configured to control reading of charge accumulated in a plurality of pixels and be individually connected to respective pixels on any one given row. The exposure time control section is configured to perform control so that exposure times of pixels become longer as moving from pixels arranged at the center of any one given row toward pixels arranged in the periphery in accordance with signals controlling exposure times from the first read signal line and the second read signal line.

Note that in respective drawings used in the following description, respective components may be shown at different scales so that the respective components are shown in such a size that the components are recognizable in the drawings, and the present invention is not limited to only the quantity of the components, shape of the components, ratio in size among the components and relative positional relationship among the components described in these drawings.

Hereinafter, embodiments of the present invention will be described with reference to the accompanying drawings.

### First Embodiment

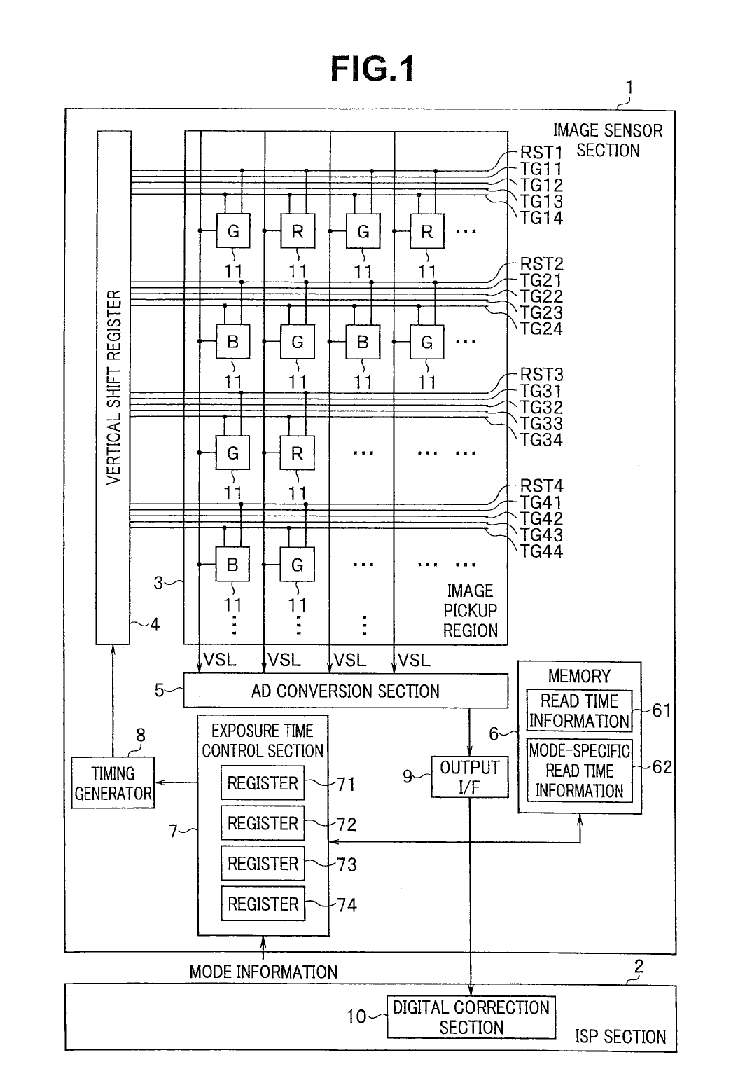

FIG. 1 is a block diagram illustrating an example of a configuration of a solid-state image sensor device according to a first embodiment. The solid-state image sensor device of the present embodiment is configured by including an image sensor section 1 and an image signal processing section (hereinafter, referred to as “ISP section”) 2.

The image sensor section 1 is provided with an image pickup region 3 in which a plurality of unit pixels 11 are arranged in a two-dimensional matrix form in row and column directions, a vertical shift register 4 as a selection section configured to select the unit pixels 11 for each row, and an AD conversion section 5 configured to digitize analog signals outputted from the unit pixels 11. In the unit pixels 11 shown in FIG. 1, pixels marked “R” are pixels in which color filters configured to allow light mainly in a red wavelength region to pass therethrough are arranged, and pixels marked “B” are pixels in which color filters configured to allow light mainly in a blue wavelength region to pass therethrough are arranged. In addition, in the unit pixels 11 shown in FIG. 1, pixels marked “G” are pixels in which color filters configured to allow light mainly in a green wavelength region to pass therethrough are arranged.

Note that the example shown in FIG. 1 shows a case where color filters generally used as a Bayer array are arranged. That is, color filters are arranged so that different color signals are acquired in the row direction and the column direction from neighboring unit pixels 11.

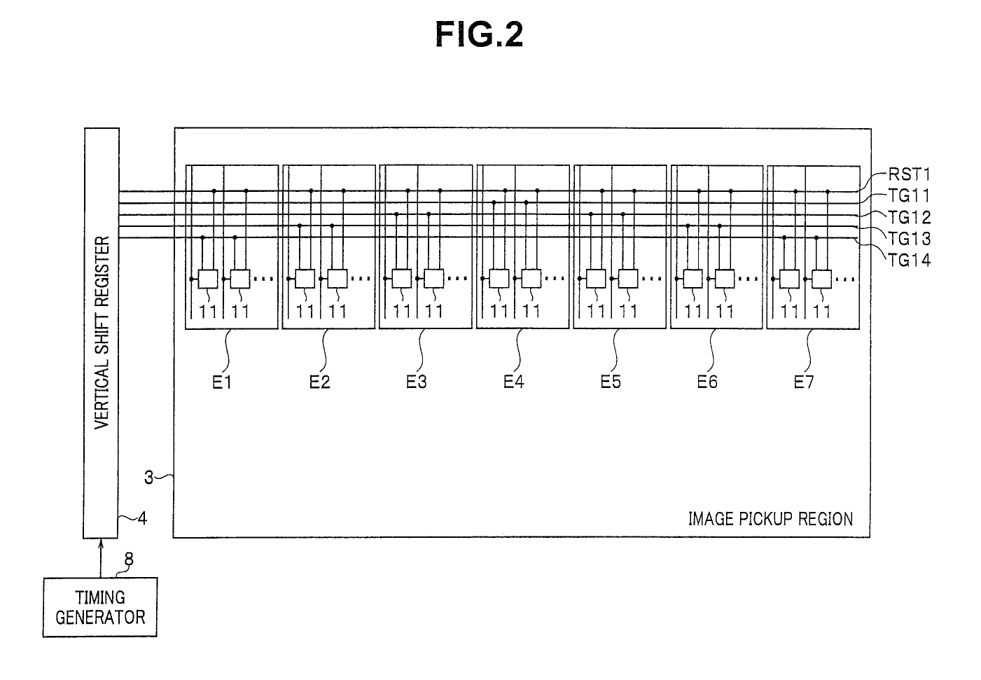

The unit pixels 11 in the vertical (column) direction are connected via a vertical signal line VSL. In addition, the unit pixels 11 in the horizontal (row) direction are connected via a reset signal line RST and also connected to any one of four read signal lines TG. More specifically, the unit pixels 11 in the horizontal direction are connected to any one of the four read signal lines TG in accordance with pixel areas E1 to E7 arranged as shown in FIG. 2 which will be described later.

Furthermore, the image sensor section 1 includes a memory section 6 configured to store read time information 61 which is information to change a read time of the unit pixels 11 arranged for each pixel area E1 to E7 and mode-specific read time information 62 which is information to change a read time for each photographing mode.

Furthermore, the image sensor section 1 also includes an exposure time control section 7 to control exposure times of the unit pixels 11 arranged for each in the pixel areas E1 to E7. As will be described later, exposure times of the unit pixels 11 arranged in the pixel areas E1 and E7 are the same, exposure times of the unit pixels 11 arranged in the pixel areas E2 and E6 are the same, and exposure times of the unit pixels 11 arranged in the pixel areas E3 and ES are the same. Therefore, the exposure time control section 7 includes a register 71 configured to control exposure times of the unit pixels 11 arranged in the pixel areas E1 and E7, a register 72 configured to control exposure times of the unit pixels 11 arranged in the pixel areas E2 and E6, a register 73 configured to control exposure times of the unit pixels 11 arranged in the pixel areas E3 and ES, and a register 74 configured to control exposure times of the unit pixels 11 arranged in the pixel area E4. The exposure time control section 7 reads read time information 61 of a memory 6, sets a read time information in each register 71 to 74 and controls the exposure times of the unit pixels 11 arranged in the pixel areas E1 to E7.

Furthermore, the image sensor section 1 includes a timing generator 8 configured to generate a predetermined clock signal necessary for operation of each unit pixel 11 according to a setting of the exposure time control section 7 and an output I/F 9 configured to output an image signal obtained by digitizing a signal outputted from each unit pixel 11.

The ISP section 2 includes a digital correction section 10 configured to digitally correct the digitized image signal outputted from the output I/F 9.

Note that only some of the unit pixels 11 arranged in the image pickup region 3 are shown in FIG. 1. Actually, for example, over several tens of millions of unit pixels 11 are arranged in the image pickup region 3.

Next, a detailed configuration of the image pickup region 3 will be described using FIG. 2. FIG. 2 is a block diagram illustrating a detailed configuration of the image pickup region 3 of the present embodiment. Note that in FIG. 2, only the unit pixels 11 on the first row are shown, but other rows also have similar configurations.

As shown in FIG. 2, the horizontal direction of the image pickup region 3 is divided into the pixel areas E1 to E7 and at least one or more unit pixels 11 are arranged in the respective pixel areas E1 to E7. Note that in FIG. 2, the pixel areas E1 to E7 have the same size, but the pixel areas E1 to E7 may have different sizes. That is, the number of unit pixels 11 arranged in the respective pixel areas E1 to E7 need not be the same but may differ from each other.

The unit pixels 11 in the respective pixel areas E1 to E7 are connected to a reset signal line RST1 and also connected to any one of the read signal lines TG11 to TG14. The unit pixels 11 in the pixel area E4 are connected to the read signal line TG11. In addition, the unit pixels 11 in the pixel areas E3 and E5 are connected to the read signal line TG12. Moreover, the unit pixels 11 in the pixel areas E2 and E6 are connected to the read signal line TG13. The unit pixels 11 in the pixel areas E1 and E7 are connected to the read signal line TG14.

In the present embodiment, exposure times of the unit pixels 11 of the respective pixel areas E1 to E7 are changed by changing the read time for each of the read signal lines TG11 to TG14. More specifically, the exposure time is increased from the pixel area E4 at the center of the image pickup region 3 toward the outside pixel areas E1 and E7.

That is, the exposure times of the unit pixels 11 in the pixel area E4 at the center of the image pickup region 3 are shortened and the exposure times of the unit pixels 11 in the pixel area E3 and E5 are made longer than the exposure times of the unit pixels 11 in the pixel area E4. In addition, the exposure times of the unit pixels 11 in the pixel areas E2 and E6 are made longer than the exposure times of the unit pixels 11 in the pixel areas E3 and ES. Moreover, the exposure times of the unit pixels 11 in the pixel areas E1 and E7 are made longer than the exposure times of the unit pixels 11 in the pixel areas E2 and E6.

Thus, by increasing the exposure times from the pixel area E4 at the center of the image pickup region 3 toward the pixel areas E1 and E7 outside, it is possible to make the amount of signal of the unit pixels 11 arranged in the pixel areas E1 to E3, and E5 to E7 approximate to the signal amount of the unit pixels 11 arranged in the pixel area E4 at the center.

Note that the mode-specific read time information 62 of the memory 6 stores optimization conditions of exposure times of the unit pixels 11 in the pixel areas E1 to E7 beforehand for each photographing mode, for example, full, binning, 1080p, 720p, HDR (high dynamic range), long time exposure mode or the like. In a predetermined photographing mode, the exposure time control section 7 reads an optimization condition in the predetermined photographing mode from the mode-specific read time information 62, sets the optimization condition in the respective registers 71 to 74, and can thereby automatically adjust the exposure times of the unit pixels 11 in the pixel areas E1 to E7 for each photographing mode. Note that the function of the mode-specific read time information 62 may be included in the read time information 61.

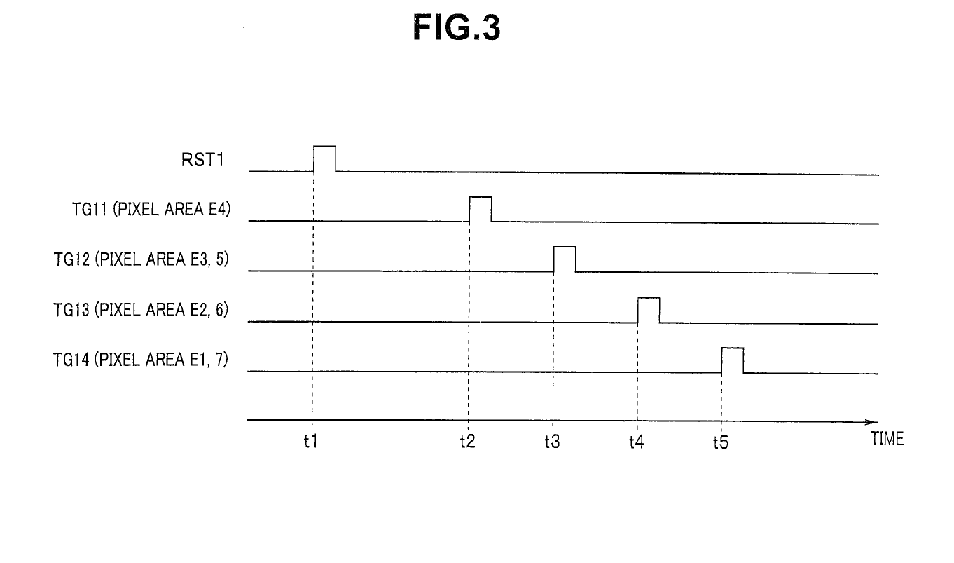

Next, a pixel signal read operation by the solid-state image sensor device configured as described above will be described using FIG. 3. FIG. 3 is a timing chart illustrating timing at which a pixel signal is acquired from the unit pixel 11.

In an image pickup mode, the exposure time control section 7 reads the read time information 61 of the memory 6. The exposure time control section 7 sets a pixel area E4 read time in the register 71, pixel area E3 and ES read times in the register 72, pixel area E2 and E6 read times in the register 73, and pixel area E1 and E7 read times in the register 74 respectively. The exposure time control section 7 controls the timing generator 8 with reference to the read times set in the respective registers 71 to 74 so as to generate each pulse signal to acquire and read a pixel signal. The timing generator 8 generates each pulse signal to acquire and read a pixel signal based on the control of the exposure time control section 7 and outputs each pulse signal to the vertical shift register 4.

First, a pulse signal is outputted from the vertical shift register 4 to the reset signal line RST1 (time t1). The reset signal line RST1 is connected to the unit pixels 11 in the pixel areas E1 to E7. This causes accumulation of charge to start in the unit pixels 11 in the pixel areas E1 to E7.

Next, when the unit pixels 11 in the pixel area E4 are exposed until the exposure time set in the register 71 of the exposure time control section 7, a pulse signal is outputted from the vertical shift register 4 to the read signal line TG11 (time t2). The read signal line TG11 is connected to the unit pixels 11 in the pixel area E4. Thus, charge of the unit pixels 11 in the pixel area E4 is read and secured in each floating diffusion.

Next, when the unit pixels 11 in the pixel areas E3 and E5 are exposed until the exposure time set in the register 72 of the exposure time control section 7, a pulse signal is outputted from the vertical shift register 4 to the read signal line TG12 (time t3). The read signal line TG12 is connected to the unit pixels 11 in the pixel areas E3 and E5. Thus, charge of the unit pixels 11 in the pixel areas E3 and E5 is read and secured in each floating diffusion.

Next, when the unit pixels 11 in the pixel areas E2 and E6 are exposed until the exposure time set in the register 73 of the exposure time control section 7, a pulse signal is outputted from the vertical shift register 4 to the read signal line TG13 (time t4). The read signal line TG13 is connected to the unit pixels 11 in the pixel areas E2 and E6. Thus, charge of the unit pixels 11 in the pixel areas E2 and E6 is read and secured in each floating diffusion.

Next, when the unit pixels 11 in the pixel areas E1 and E7 are exposed until the exposure time set in the register 74 of the exposure time control section 7, a pulse signal is outputted from the vertical shift register 4 to the read signal line TG14 (time t5). The read signal line TG14 is connected to the unit pixels 11 in the pixel areas E1 and E7. Thus, charge of the unit pixels 11 in the pixel areas E1 and E7 is read and secured in each floating diffusion.

When all the charge of the unit pixels 11 in the pixel areas E1 to E7 is read, charge is read from each floating diffusion into the vertical signal line VSL and outputted as pixel signals to the AD conversion section 5. The pixel signals are then converted to digital signals in the AD conversion section 5 and a reading operation on pixel signals on the first row is completed. The pixel signals digitized by the AD conversion section 5 are outputted to the digital correction section 10 via the output I/F 9.

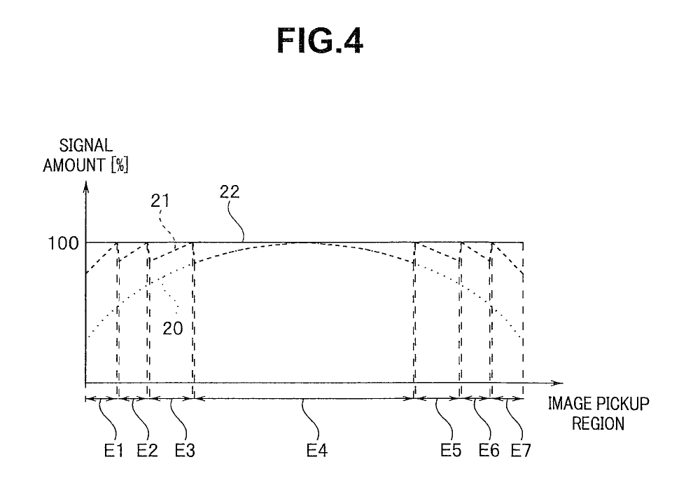

FIG. 4 is a diagram illustrating a relationship between an image pickup region and an amount of signal.

A dotted line 20 in FIG. 4 indicates an amount of signal when the pixel areas E1 to E7 have the same exposure time. As shown by the dotted line 20, when the exposure times are the same, the amount of signal decreases from the center of the image pickup region 3 toward outside. That is, the closer to the center of the image pickup region 3, the higher the amount of signal becomes, and the amount of signal decreases from the center toward the outside. That is, the amount of signal decreases in order of the pixel area E4, the pixel areas E3 and E5, the pixel areas E2 and E6, and the pixel areas E1 and E7.

In the present embodiment, read signal lines TG11 to TG14 are provided, the area is divided into seven pixel areas E1 to E7 in the horizontal direction and an exposure time is set for each unit pixel 11 in the pixel areas E1 to E7. The exposure times of the pixel areas E 1 to E7 are set so as to increase in order of pixel areas outside the pixel area E4 at the center in the horizontal direction, that is, the pixel areas E3 and ES, the pixel areas E2 and E6, and the pixel areas E1 and E7. In this way, by increasing the exposure times of the unit pixels 11 in the pixel areas E1 to E7 from the center toward the outside, the amount of signal in the pixel areas E1 to E3 and ES to E7 is increased as shown by a broken line 21. This allows the amount of signal of the unit pixels 11 in the pixel areas E1 to E3, and E5 to E7 to approximate to that of the unit pixels 11 in the pixel area E4 at the center in the horizontal direction.

However, when the unit pixels 11 arranged on the center side of the image pickup region 3 are compared to the unit pixels 11 arranged outside, for example, the unit pixels 11 in the pixel area E1, the unit pixels 11 arranged outside have a smaller amount of signal. Therefore, the amounts of signal of read image signals may form a concavo-convex line (serrated, that is, sawtooth line) as shown by the broken line 21.

Thus, the digital correction section 10 corrects the concavo-convex amount of signal of the digitized pixel signal inputted via the output I/F 9 so that the amount of signal becomes constant as shown by a solid line 22. In the example of FIG. 4, correction is made so that the amount of signal becomes the same as that substantially at the center in the pixel area E4.

In the present embodiment, four read signal lines TG11 to TG14 are provided in the horizontal direction and the area is divided into seven pixel areas E1 to E7, but the present invention is not limited to this. For example, the number of read signal lines TG is not limited to four, but may be two or more. The number of divisions of the pixel area E is determined according to the number of read signal lines TG. The number of divisions of the pixel area E in the horizontal direction is assumed to be 2n−1 (n: the number of read signal lines TG). For example, when the number of read signal lines TG is three, the area may be divided into five pixel areas E, whereas when the number of read signal lines TG is five, the area may be divided into nine pixel areas E.

As described above, in the solid-state image sensor device 1, a plurality of read signal lines TG11 to 14 are provided in the horizontal direction and the unit pixels 11 in the horizontal direction are divided into a plurality of pixel areas E1 to E7. In the solid-state image sensor device 1, the unit pixels 11 of the divided pixel areas E1 to E7 are connected to any one of the plurality of read signal lines TG11 to 14. In the solid-state image sensor device 1, signal pulses of different read times are outputted from the plurality of read signal lines TG11 to 14 so as to change the exposure time for each unit pixel 11 arranged in the pixel areas E1 to E7. As a result, shading can be corrected without manufacturing the image pickup region 3 of a complicated structure by changing the pitch of the microlens and performing complicated data processing.

Thus, according to the solid-state image sensor device of the present embodiment, it is possible to improve shading characteristics with a simple structure and without taking time for data processing.

### Second Embodiment

Next, a second embodiment will be described.

The solid-state image sensor device has been described in the first embodiment in which the exposure times of the unit pixels 11 in the horizontal direction are changed for each in the pixel areas E1 to E7. In the second embodiment, a solid-state image sensor device will be described in which the exposure times of the unit pixels 11 are changed for each row in addition to changing the exposure times for each in the pixel areas E1 to E7.

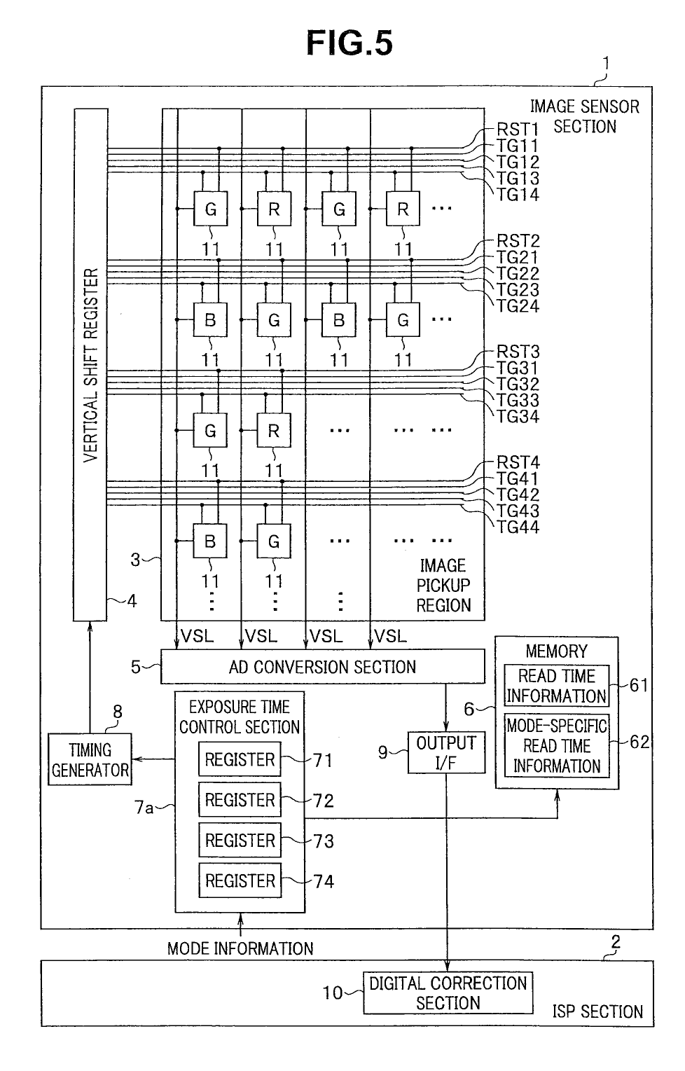

FIG. 5 is a block diagram illustrating an example of a configuration of a solid-state image sensor device according to the second embodiment. Note that in FIG. 5, components similar to those in FIG. 1 are assigned the same reference numerals and description thereof will be omitted.

The solid-state image sensor device of the present embodiment is configured using an exposure time control section 7a instead of the exposure time control section 7 in FIG. 1. The exposure time control section 7a changes not only the exposure times for each pixel area E1 to E7 (see FIG. 2) but also the exposure times of the unit pixels 11 for each row.

More specifically, the exposure time control section 7a performs control so as to shorten the exposure times on a row at the center of the image pickup region 3 and increase the exposure times on rows outside the row at the center. In other words, the exposure time control section 7a performs control so as to make the exposure times of the unit pixels 11 on the first row and the final row the longest, make the exposure times of the unit pixels 11 closer to the row at the center shorter and make the exposure times of the unit pixels 11 on the row at the center the shortest.

That is, the exposure time control section 7a makes the exposure times of the unit pixels 11 on the first row connected to TG11 to TG14 the longest and makes the exposure times of the unit pixels 11 on the second row connected to TG21 to TG24 shorter than the exposure time of the unit pixels 11 on the first row connected to TG11 to TG14. Similarly, the exposure time control section 7a makes the exposure times of the unit pixels 11 on the third row connected to TG31 to TG34 shorter than the exposure times of the unit pixels 11 on the second row connected to TG21 to TG24. Similarly, the exposure time control section 7a makes the exposure times of the unit pixels 11 on the fourth row connected to TG41 to TG44 shorter than the exposure times of the unit pixels 11 on the third row connected to TG31 to TG34. Moreover, the exposure time control section 7a makes the exposure times closer to the row at the center of the image pickup region 3 shorter and makes the exposure times of the unit pixels 11 on the row at the center of the image pickup region 3 the shortest. The exposure time control section 7a gradually makes the exposure times of the unit pixels 11 longer from the row at the center toward the final row.

By making the exposure times of the unit pixels 11 longer from the row at the center of the image pickup region 3 toward the outermost row, the amount of signal of the unit pixels 11 arranged outside the row at the center is approximated to the amount of signal of the unit pixels 11 arranged on the row at the center.

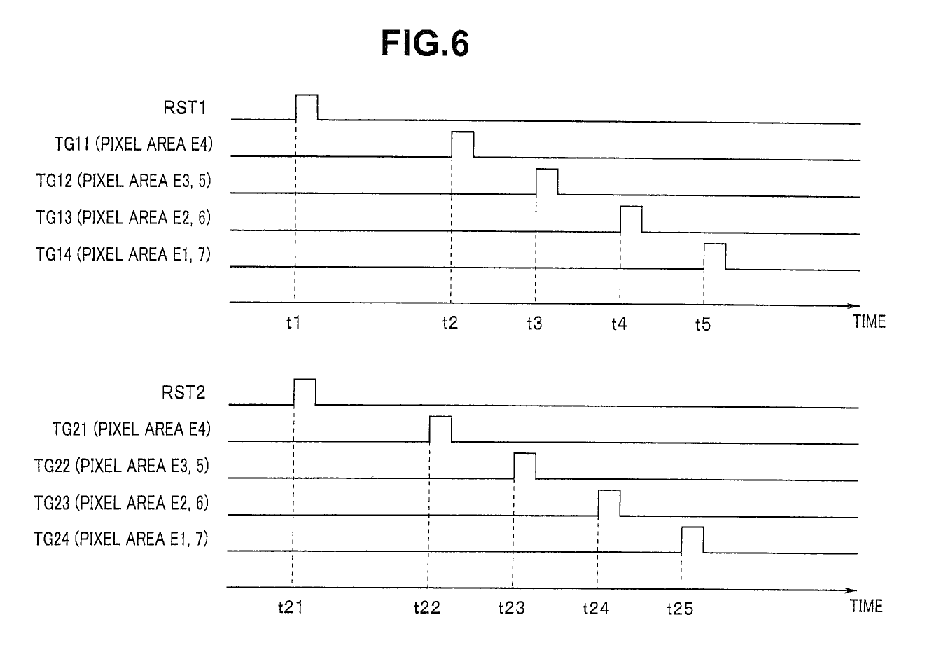

Next, an operation of reading pixel signals by the solid-state image sensor device configured as described above will be described using FIG. 6. FIG. 6 is a timing chart illustrating timing at which a pixel signal is acquired from the unit pixel 11.

As shown in FIG. 6, a pulse signal is inputted from the reset signal line RST1 to the unit pixels 11 on the first row at time t1 and accumulation of charge is started. Next, a pulse signal is inputted from the read signal line TG11 to the unit pixels 11 in the pixel area E4 at time t2 and charge of the unit pixels 11 in the pixel area E4 is read. Next, a pulse signal is inputted from the read signal line TG12 to the unit pixels 11 in the pixel areas E3 and E5 at time t3 and charge of the unit pixels 11 in the pixel areas E3 and E5 is read. Next, a pulse signal is inputted from the read signal line TG13 to the unit pixels 11 in the pixel areas E2 and E6 at time t4 and charge of the unit pixels 11 in the pixel areas E2 and E6 is read. Next, a pulse signal is inputted from the read signal line TG14 to the unit pixels 11 in the pixel areas E1 and E7 at time t5 and charge of the unit pixels 11 in the pixel areas E1 and E7 is read.

On the other hand, a pulse signal is inputted from the reset signal line RST2 to the unit pixels 11 on the second row at time t21 and accumulation of charge is started. Here, the pulse signals are inputted at the same; at time t1 and time t21. Next, a pulse signal is inputted from the read signal line TG21 to the unit pixels 11 in the pixel area E4 on the second row at time t22 and charge of the unit pixel 11 in the pixel area E4 is read. In this case, time t22 is set to be ahead of time t2 which is a read time of the unit pixels 11 in the pixel area E4 on the first row.

Next, a pulse signal is inputted from the read signal line TG22 to the unit pixels 11 in the pixel areas E3 and E5 on the second row at time t23 and charge of the unit pixels 11 in the pixel areas E3 and E5 is read. In this case, time t23 is set to be ahead of time t3 which is a read time of the unit pixels 11 in the pixel areas E3 and E5 on the first row.

Next, a pulse signal is inputted from the read signal line TG23 to the unit pixels 11 in the pixel areas E2 and E6 on the second row at time t24 and charge of the unit pixels 11 in the pixel areas E2 and E6 is read. In this case, time t24 is set to be ahead of time t4 which is a read time of the unit pixels 11 in the pixel areas E2 and E6 on the first row.

Next, a pulse signal is inputted from the read signal line TG24 to the unit pixels 11 in the pixel areas E1 and E7 on the second row at time t25 and charge of the unit pixels 11 in the pixel areas E1 and E7 is read. In this case, time t25 is set to be ahead of time t5 which is a read time of the unit pixels 11 in the pixel areas E1 and E7 on the first row.

In this way, the exposure time control section 7a makes the read time of each pixel area on the second row shorter than the read time on the first row. The exposure time control section 7a performs control so as to gradually shorten the read time from the second row onward toward the row at the center so that the exposure times of the unit pixels 11 in the vertical direction become substantially the same for each row. Note that the read time is controlled for each row in the present embodiment, but the present invention is not limited to this. Effects of the present embodiment can also be achieved by dividing the row into a plurality of regions, making the read time of the plurality of row regions located in the center region the shortest and making the read time of the plurality of row regions located outermost the longest.

As described above, the solid-state image sensor device of the present embodiment changes not only the exposure times of the unit pixels 11 in the horizontal direction by the image pickup areas E1 to E7 but also the exposure times of the unit pixels 11 for each row. This improves two-dimensional shading characteristics in the horizontal direction and vertical direction.

Thus, according to the solid-state image sensor device of the present embodiment, it is possible to improve shading characteristics in the vertical direction in addition to the effects of the first embodiment.

### Third Embodiment

Next, a third embodiment will be described.

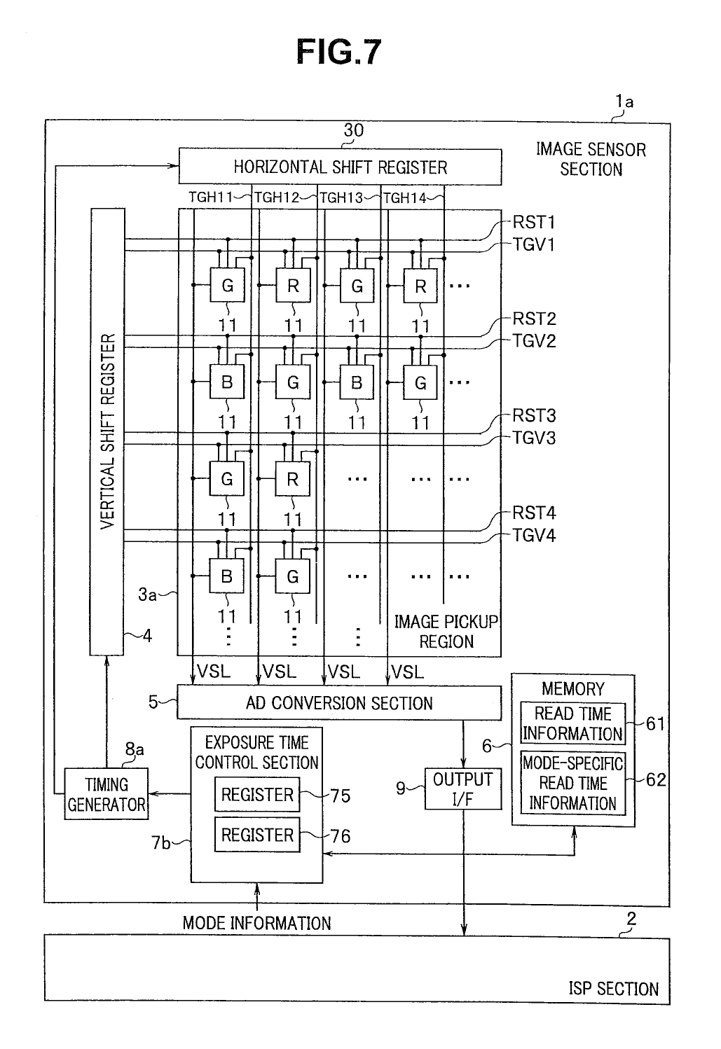

FIG. 7 is a block diagram illustrating an example of a configuration of a solid-state image sensor device according to a third embodiment. Note that in FIG. 7, components similar to those in FIG. 1 are assigned the same reference numerals and description thereof will be omitted.

The solid-state image sensor device of the present embodiment is configured so as to use an image pickup region 3a, an exposure time control section 7b, and a timing generator 8a instead of the image pickup region 3, the exposure time control section 7, and the timing generator 8 in FIG. 1, respectively, and additionally include a horizontal shift register 30. Furthermore, the solid-state image sensor device of the present embodiment is configured by deleting the digital correction section 10 in FIG. 1.

The exposure time control section 7b includes a register 75 configured to set a read time in the vertical direction and a register 76 configured to set a read time in the horizontal direction.

The timing generator 8a outputs timing to the vertical shift register 4 and the horizontal shift register 30 that generate predetermined clock signals necessary for operation of each unit pixel 11 according to a setting of the exposure time control section 7b.

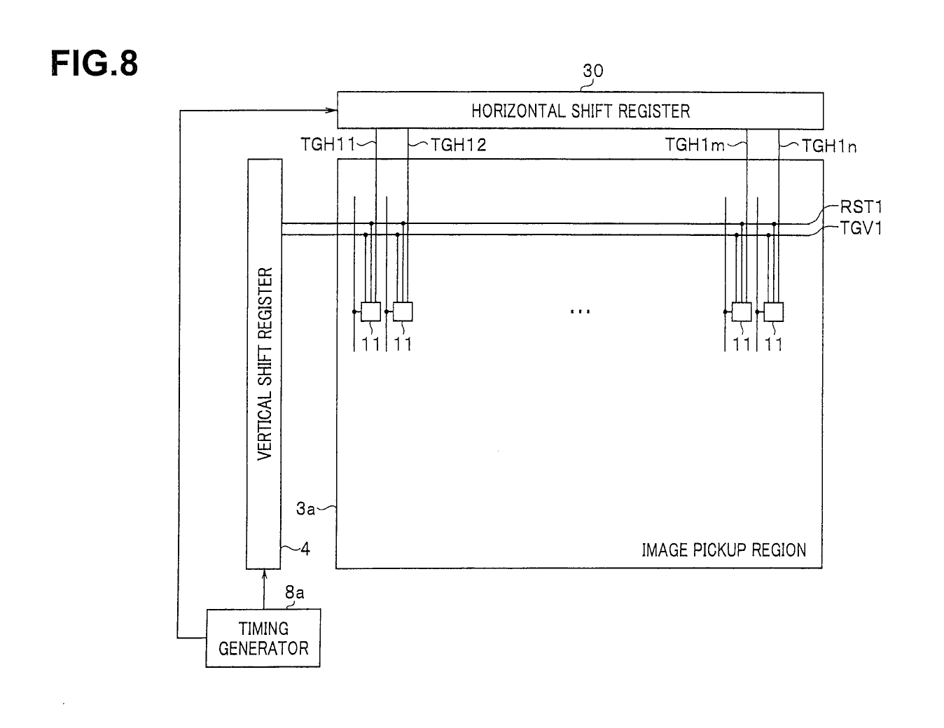

Next, a detailed configuration of the image pickup region 3a will be described using FIG. 8. FIG. 8 is a block diagram illustrating the detailed configuration of the image pickup region 3a of the present embodiment. Note that in FIG. 8, components similar to those in FIG. 2 are assigned the same reference numerals and description thereof will be omitted. In FIG. 8, only the unit pixels 11 on the first row are described but a similar configuration is also adopted for other rows.

As shown in FIG. 8, the unit pixels 11 in the horizontal direction are connected to the reset signal line RST1 and the read signal line TGV1 from the vertical shift register 4. Furthermore, the unit pixels 11 in the horizontal direction are connected to read signal lines TGH11, TGH12, . . . , TGH1m, TGH1n from the horizontal shift register 30.

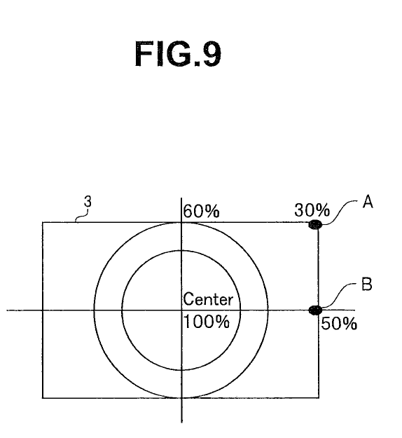

Here, a relationship between each unit pixel 11 of the image pickup region 3 and an amount of signal will be described. FIG. 9 is a diagram illustrating a relationship between each unit pixel 11 of the image pickup region 3 and an amount of signal.

As shown in FIG. 9, when the amount of signal of the unit pixel 11 at the center of the image pickup region 3 is assumed to be 100%, the amount of signal of the unit pixel 11 at the center in the horizontal direction and at the top in the vertical direction is approximately 60%. The amount of signal of the unit pixel 11 (mark A) at the rightmost in the horizontal direction and at the top in the vertical direction is approximately 30% and the amount of signal of the unit pixel 11 (mark B) at the rightmost in the horizontal direction and at the center in the vertical direction is approximately 50%

In the present embodiment, the exposure time of each unit pixel 11 is changed using the read signal line TGV1 and read signals from the read signal lines TGH11 to TGH1n. More specifically, in the case of the unit pixel 11 (mark B) whose amount of signal is 50%, the exposure time of this unit pixel 11 is made to become twice that of the unit pixel 11 at the center of the image pickup region 3. Thus, the amount of signal of the unit pixel 11 (mark B) is made to approximate to 100%, the same amount of signal of the unit pixel 11 at the center of the image pickup region 3.

Such control of exposure times can be applied to all unit pixels 11 using read signal lines TGV in the horizontal direction and read signal lines TGH in the vertical direction. That is, it is possible to cause the amounts of signal of all unit pixels 11 to approximate to 100%, the same amount of signal as that of the unit pixel 11 at the center of the image pickup region 3. Therefore, the amount of signal of the unit pixel 11 can be set to a constant amount shown by the solid line 22 in FIG. 4 instead of the concavo-convex shape shown by the broken line 21 in FIG. 4. Thus, it is no longer necessary to make digital correction in the ISP section 2 in the present embodiment and the digital correction section 10 in FIG. 1 becomes unnecessary.

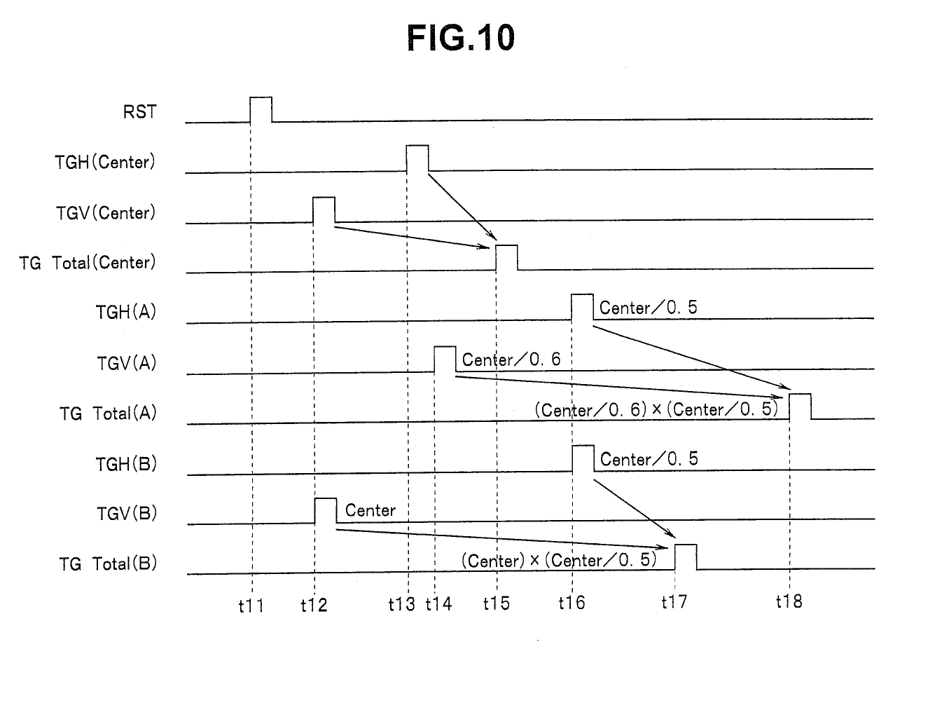

Next, an operation of reading pixel signals by the solid-state image sensor device configured as described above will be described using FIG. 10. FIG. 10 is a timing chart illustrating timing at which pixel signals are acquired from the unit pixel 11.

First, reading of charge of the unit pixel 11 at the center of the image pickup region 3 will be described.

A pulse signal is outputted from the vertical shift register 4 to the reset signal line RST1 (time t11), and when an exposure time set in the register 75 of the exposure time control section 7b comes, a pulse signal is outputted from the vertical shift register 4 to the read signal line TGV (time t12). When an exposure time set in the register 76 of the exposure time control section 7b comes, a pulse signal is outputted from the horizontal shift register 30 to the read signal line TGH (time t13). Charge of the unit pixel 11 at the center of the image pickup region 3 is read according to these pulse signals (time t15).

Next, reading of charge of the unit pixel 11 (mark A) at the rightmost in the horizontal direction and at the top in the vertical direction will be described.

When an exposure time (center/0.6) set in the register 75 of the exposure time control section 7b comes, a pulse signal is outputted from the vertical shift register 4 to the read signal line TGV (time t14). Furthermore, when an exposure time (center/0.5) set in the register 76 of the exposure time control section 7b comes, a pulse signal is outputted from the horizontal shift register 30 to the signal line TGH (time t16). Charge of the unit pixel 11 (mark A) is read in according to these pulse signals (time t18). The exposure time in this case becomes 3.33 times the exposure time of the unit pixel 11 at the center of the image pickup region 3 according to (center/0.6)×(center/0.5).

Next, reading of charge of the unit pixel (mark B) at the rightmost in the horizontal direction and at the center in the vertical direction will be described.

When an exposure time (center) set in the register 75 of the exposure time control section 7b comes, a pulse signal is outputted from the vertical shift register 4 to the read signal line TGV (time t12). Furthermore, when an exposure time (center/0.5) set in the register 76 of the exposure time control section 7b comes, a pulse signal is outputted from the horizontal shift register 30 to the read signal line TGH (time t16). Charge of the unit pixel 11 (mark B) is read according to these pulse signals (time t17). The exposure time in this case becomes twice the exposure time of the unit pixel 11 at the center of the image pickup region 3 according to (center)×(center/0.5).

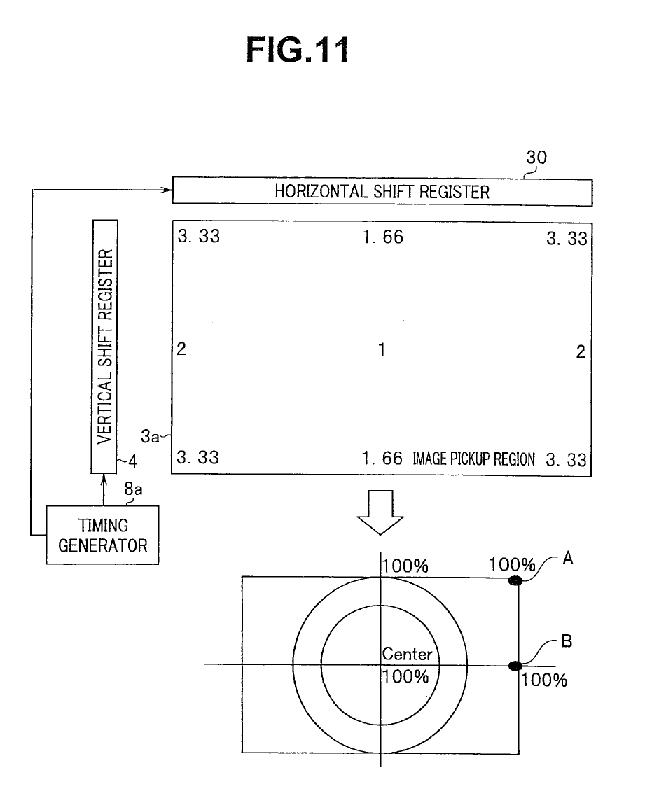

FIG. 11 is a diagram illustrating an exposure time of each unit pixel 11 of the image pickup region 3. As shown in FIG. 11, when the exposure time at the center of the image pickup region 3 is assumed to be 1, the exposure time of the unit pixel 11 at the center in the horizontal direction and at the top in the vertical direction becomes 1.66 times. The amount of signal of the unit pixel 11 is 60% of the unit pixel 11 at the center of the image pickup region 3 and multiplying the exposure time 1.66 times increases the amount of signal to 100%.

The exposure time becomes 3.33 times at the unit pixel 11 (mark A) at the rightmost in the horizontal direction and at the top in the vertical direction and the exposure time becomes twice at the unit pixel (mark B) at the rightmost in the horizontal direction and at the center in the vertical direction of the image pickup region 3. The amount of signal of the unit pixel 11 (mark A) is 30% of that of the unit pixel 11 at the center of the image pickup region 3, and multiplying the exposure time 3.33 times increases the amount of signal to 100%. Similarly, the amount of signal of the unit pixel 11 (mark B) is 50% of that of the unit pixel 11 at the center of the image pickup region 3, and multiplying the exposure time twice increases the amount of signal to 100%.

As described above, the solid-state image sensor device of the present embodiment individually controls an exposure time of each unit pixel 11 using pulse signals from the vertical shift register 4 and the horizontal shift register 30, and thereby makes the amounts of signal of all unit pixels 11 reach 100%. This eliminates the necessity for digital correction in the ISP section 2 in the solid-state image sensor device of the present embodiment.

In addition to the effects of the first embodiment, the solid-state image sensor device of the present embodiment requires no more digital correction, and can thereby improve the processing speed compared to the solid-state image sensor device of the first embodiment. Moreover, since the solid-state image sensor device of the present embodiment can delete the digital correction section 10 of FIG. 1, it is possible to reduce the circuit scale compared to the solid-state image sensor device of the first embodiment.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalents are intended to cover such forms or modifications as would fall within the scope and spirit of the inventions.

What is claimed is:

1. A solid-state image sensor device comprising:
an image pickup section configured to have a plurality of pixels arranged two-dimensionally in a matrix form;
a first read signal line configured to control reading of charge accumulated in the plurality of pixels and be connected to a first pixel arranged at a center of a first row on which the plurality of pixels are arranged;
a second read signal line configured to control reading of charge accumulated in the plurality of pixels and be connected to a second pixel arranged in a periphery outside the center of the first row; and
an exposure time control section configured to perform control so that an exposure time of the second pixel becomes longer than an exposure time of the first pixel.

2. The solid-state image sensor device according to claim 1, further comprising a timing generator configured to output a signal for controlling the exposure time of the first pixel to the first read signal line and output a signal for controlling the exposure time of the second pixel to the second read signal line based on control by the exposure time control section.

3. The solid-state image sensor device according to claim 1, further comprising a memory configured to store information on the exposure time of the first pixel and the exposure time of the second pixel.

4. The solid-state image sensor device according to claim 3, wherein the exposure time control section further comprises a register configured to set information on the exposure time of the first pixel and the exposure time of the second pixel stored in the memory.

5. The solid-state image sensor device according to claim 3, wherein the memory stores information for changing the exposure time of the first pixel and the exposure time of the second pixel for each photographing mode.

6. The solid-state image sensor device according to claim 5, wherein when information on a predetermined photographing mode is inputted, the exposure time control section reads an exposure time corresponding to the predetermined photographing mode from the memory and sets the exposure time in the register.

7. The solid-state image sensor device according to claim 1, further comprising a conversion section configured to convert pixel signals read from the plurality of pixels from analog signals to digital signals.

8. The solid-state image sensor device according to claim 7, further comprising a digital correction section configured to digitally correct the pixel signals converted by the conversion section to digital signals.

9. The solid-state image sensor device according to claim 1, wherein color filters for allowing light of a predetermined wavelength region to pass therethrough are arranged in the plurality of pixels.

10. The solid-state image sensor device according to claim 1, further comprising a third pixel and a fourth pixel configured to be arranged on a second row located closer to a center direction of the image pickup section than the first row on which the first and second pixels are arranged, the third pixel being located closer to the center of the second row than the fourth pixel, wherein:
the exposure time control section makes an exposure time of the fourth pixel longer than an exposure time of the third pixel and shorter than the exposure time of the second pixel, and
makes the exposure time of the third pixel shorter than the exposure time of the first pixel.

11. The solid-state image sensor device according to claim 10, comprising three or more rows configured to include pixels connected to the first and second read signal lines, wherein
the exposure time control section performs control so that exposure times of pixels become longer as moving from rows arranged on the center side of the image pickup section toward rows arranged outside the center side among the three rows.

12. A solid-state image sensor device comprising:
an image pickup section configured to have a plurality of pixels arranged two-dimensionally in a matrix form;
three or more read signal lines configured to control reading of charge accumulated in the plurality of pixels, the three or more read signal lines being connected to any one of pixels arranged in divided areas obtained by dividing pixels on a first row on which the plurality of pixels are arranged into a plurality of areas; and
an exposure time control section configured to perform control so that exposure times of the respective pixels arranged in the plurality of areas become longer as moving from an area at a center toward areas in a periphery.

13. The solid-state image sensor device according to claim 12, further comprising a timing generator configured to output a signal for performing control so that the exposure times become longer as moving from the area at the center toward the areas in the periphery based on the control by the exposure time control section to the three or more read signal lines.

14. A solid-state image sensor device comprising:
an image pickup section configured to have a plurality of pixels arranged two-dimensionally in a matrix form;
a first read signal line configured to control reading of charge accumulated in the plurality of pixels and be connected to pixels on any one given row on which the plurality of pixels are arranged;
a second read signal line configured to control reading of charge accumulated in the plurality of pixels and be individually connected to the respective pixels on the any one given row; and
an exposure time control section configured to perform control so that exposure times of pixels become longer as moving from pixels arranged at the center of the any one given row toward pixels arranged in a periphery in accordance with signals for controlling exposure times from the first read signal line and the second read signal line.

15. The solid-state image sensor device according to claim 14, further comprising a timing generator configured to output a signal for performing control so that the exposure times become longer as moving from pixels arranged at the center toward pixels arranged in the periphery based on the control by the exposure time control section to the first read signal line and the second read signal line.

16. The solid-state image sensor device according to claim 14, further comprising a memory configured to store information on exposure times of pixels arranged at the center and pixels arranged in the periphery.

17. The solid-state image sensor device according to claim 16, wherein the exposure time control section further comprises a register configured to set information on exposure times of the pixels arranged in the center and exposure times of the pixels arranged in the periphery stored in the memory.

18. The solid-state image sensor device according to claim 16, wherein the memory stores information for changing the exposure times of the pixels arranged in the center and exposure times of the pixels arranged in the periphery for each photographing mode.

19. The solid-state image sensor device according to claim 18, wherein when information on a predetermined photographing mode is inputted, the exposure time control section reads exposure times corresponding to the predetermined photographing mode from the memory and sets the exposure times in the register.

20. The solid-state image sensor device according to claim 14, further comprising a conversion section configured to convert pixel signals read from the plurality of pixels from analog signals to digital signals.
